(19) United States
(12) Patent Application Publication
(10) Pub. No.: US 2006/0108758 A1
(43) Pub. Date: May 25, 2006

(54) Adaptor to attach conveyance device to wheel

(76) Inventor: Edward N. McLaughlan, South Riding, VA (US)

Correspondence Address: LITMAN LAW OFFICES, LTD, PO BOX 15035, CRYSTAL CITY STATION, ARLINGTON, VA, 22215, US

(21) Appl. No.: 11/274,858

(22) Filed: Nov. 16, 2005

Related U.S. Application Data
(60) Provisional application No. 60/629,766, filed on Nov. 20, 2004.

(51) Int. Cl. B62B 5/00

(52) U.S. Cl. 280/79.4

(57) ABSTRACT

An adapter configured to attach an auxiliary wheel to a wheel of conveyance device includes a wheel cradle having first and second parallel disposed walls forming a conveyance wheel receiving channel and a wheel support floor disposed between lower edges of the parallel walls. An axle receiving bore is disposed on and projects from an exterior portion of the first wall, to receive an axle assembly of an auxiliary wheel. A plurality of reinforcing gussets are disposed on an exterior surface of the first wall and extend in a radial direction from an outward supporting surface of the axle receiving bore. A strap attachment portion is located in on an upper front and an upper rear area of wheel cradle for an attachment strap to connect to and thereby wrap around a wheel of a conveyance device received in the wheel receiving channel.

### CROSS-REFERENCE TO RELATED APPLICATION

This application claims the benefit of U.S. Provisional Patent Application Ser. No. 60/629,766, filed Nov. 20, 2004.

### BACKGROUND OF THE INVENTION

1. Field of the Invention

This invention relates to the variety of all-terrain wheels, treads and skis that support and provide mobility to personal load conveyances, such as child strollers, wagons, carts and dollies.

2. Description of the Related Art

This invention addresses the problem whereby a conveyance of personal load, such as a child stroller, wagon, cart or dolly, has wheels of such a small diameter or otherwise unsuitable type as to make traversal of terrain that is rough, uneven, unstable or otherwise compromised difficult or unproductive. While several patents have addressed movement of such conveyances over snow, mud and other granular surfaces by use of skis, sleds or skids, none address the conversion of a small diameter wheel to a large diameter wheel, via attachment of said large diameter wheel directly to the smaller. Most wheeled conveyances of this type, especially child strollers, come in two forms, either targeted at smooth, regular paved surfaces (therefore having some form of small diameter, small width, inflexible wheels typically of plastic or hard rubber) or at rough terrain (therefore having some form of large diameter, larger width, flexible wheels with tread typically of soft plastic or rubber). In some circumstances, it is advantageous to quickly and easily enable the conveyance originally designed for paved surfaces, to operate efficiently over rougher terrain. With this possible, the utility and investment of the original conveyance is extended.

For example, a child stroller most suited for sidewalks and concrete floors is taken to a grassy field, as at a country fair on unpaved surfaces. The small diameter wheels make the stroller difficult to maneuver, bumpy and jolting to the child, and prone to sudden stops, redirection or overall load displacement upon encountering surface irregularities such as rocks and ruts. Skis, sleds or skids are not useful, as the sliding friction encountered would prevent optimally efficient movement of the stroller. Larger, all-terrain wheels with deep treads for traction, air-filled rubber tires and a flexible rim for added shock absorption and softer suspension are more appropriate. While many strollers exist that have such wheels as standard equipment, no strollers to date are commonly marketed that allow for efficient, temporary replacement of one type of wheels with another, nor suspension or attachment of the original wheels to larger ones (without therefore removing the existing wheels).

Known supplements to such conveyances for mobility on sub-optimal surfaces, including skis, sleds, skids and wheeled platforms appear focused on either non-temporary use or replacement of rolling mobility with sliding mobility. No known products marketed to date are targeted at quickly and easily extending the value and utility of one class of conveyance (for example small-wheeled strollers) to that of another (for example all-terrain or jogging strollers). Various cradles exist to suspend a wheel and inhibit its movement, and therefore that of its supported conveyance. These cradles are not designed to rest on or about the axle of an auxiliary wheel, with the auxiliary wheel substituting as the rolling conveyance mechanism for the cradled wheel. Nor are these cradles typically designed to inhibit surface friction of any type, in any direction, between the cradle and the wheel resting within it.

Apparatus and their corresponding mechanisms for grabbing the wheel, surrounding the entire circumference, do not take into account the one-sided, prevailing and prominent unidirectional force (typically ground-ward) associated with a conveyance. These apparatus include those that are used as collars around circular objects, and those that are used to increase rotational leverage like jar openers. Many types of circular solid or hinged, locking or flexible collars are used as axle or pipe hubs or connectors; none of these target use around a conveyance wheel, for connecting to another, substitute conveyance wheel.

Many straps, fasteners, harnesses and cover wraps, in many kinds of materials, exist that wrap snugly around wheels (and other cylinders) of all sorts, inhibiting friction between the strap and the wheel. These are typically used either for physical movement or suspension of the wheel and the material or object attached to it (for example, a wheel lift-strap), for creating rotational leverage around the wheel (as in ajar opener or steering wheel cover), for enhancing or replacing the rotational surface friction of the wheel against other surfaces (for example, snow chains), or for simply establishing a tension-based connector between a wheel and other object (for example, when used as an axle strap for towing, or hanging strap). None of these are used as part of an apparatus to both suspend a conveyance wheel and to provide a connector to an alternate, substitute conveyance wheel.

Various devices exist that enclose or otherwise fasten around wheels, in some manner, for objectives such as providing protective housing or decoration, or for resting or suspension of objective on the wheel (for example a spare bike carrier on a vertically-suspended spare tire). None of these provide support as part of an apparatus to both suspend a conveyance wheel and to provide a connector to an alternate, substitute conveyance wheel.

Accordingly, several objects and advantages of my invention are: (a) to provide a relatively inexpensive method of quickly extending the capability of personal wheeled conveyances from traversing relatively hard and smooth surfaces to traversing uneven, rough, granular or otherwise sub-optimal terrain; (b) to provide the capability to the conveyances, without removing any existing wheels or modifying the structure or inherent composition of the conveyance in any manner; (c) to provide the capability to the conveyances, in a manner that not only retains the overall conveyance stability but improves its stability by broadening and lengthening the collective wheelbase, and improving its overall ability to absorb shock; (d) to provide the capability to the conveyances, in a reversible manner that is easily exercised with simple fastening and unfastening actions; (e) to provide the capability to the conveyances, in a manner that includes a simple mechanism for temporarily locking or otherwise impeding the rotation of the auxiliary wheels; (f) to provide the capability to the conveyances in a manner that provides for easy and reversible interchange of various auxiliary wheels, skis, or other substitute conveyance supports; and (g) to provide the capability to the conveyances in a manner that does not compromise or change the inherent, recognized or tested safety and utilitarian over-ground transport value or capabilities of the conveyance. Further objects and advantages of my invention will become apparent from a consideration of the drawings and ensuing description.

### SUMMARY OF THE INVENTION

In accordance with the present invention a manufactured cradle and fastener assembly, that suspends the supporting wheels of a personal conveyance and immobilizes them against the assembly, to which auxiliary mobility devices such as all-terrain wheels are attached in a manner easily reversed and exchanged for other devices, providing thereby substitute principle mobility and support for the conveyance, including a locking mechanism to allow temporary impedance of the rotation of auxiliary wheeled attachments. The invention is the manufactured wheel cradle itself for use in combination with additional conveyance attachments, thereby contributing to the whole cradle and fastener assembly.

These and other features of the present invention will become readily apparent upon further review of the following specification and drawings.

### BRIEF DESCRIPTION OF THE DRAWINGS

FIG. 1 shows a perspective assembly view of the wheel cradle and the optionally mating locking mechanism.

FIG. 2 shows a perspective view of the wheel cradle and optionally mating locking mechanism for attachment to a conveyance wheel and an auxiliary wheel.

FIG. 3 shows an end view of the wheel cradle and optionally mating locking mechanism for attachment to a conveyance wheel and an auxiliary wheel.

Similar reference characters denote corresponding features consistently throughout the attached drawings.

### DETAILED DESCRIPTION OF THE PREFERRED EMBODIMENTS

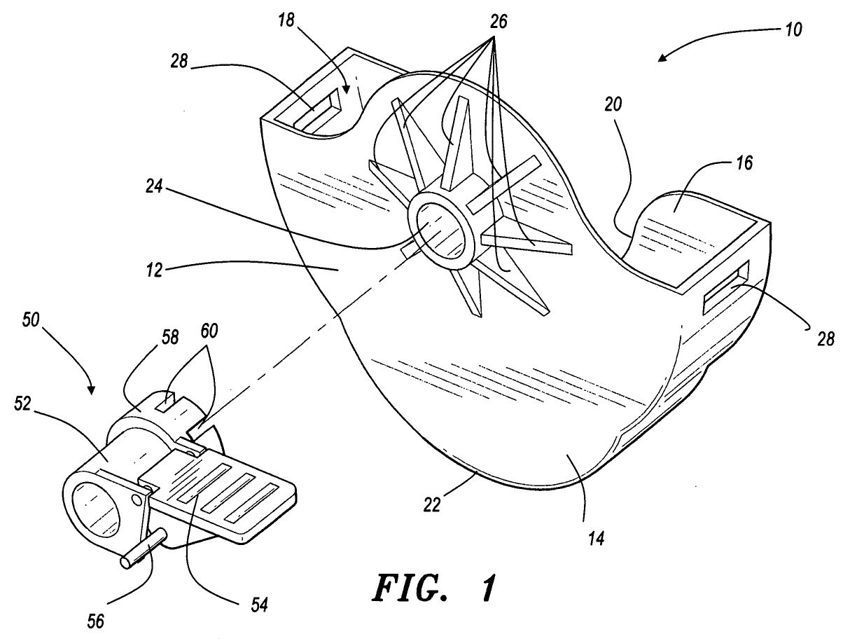

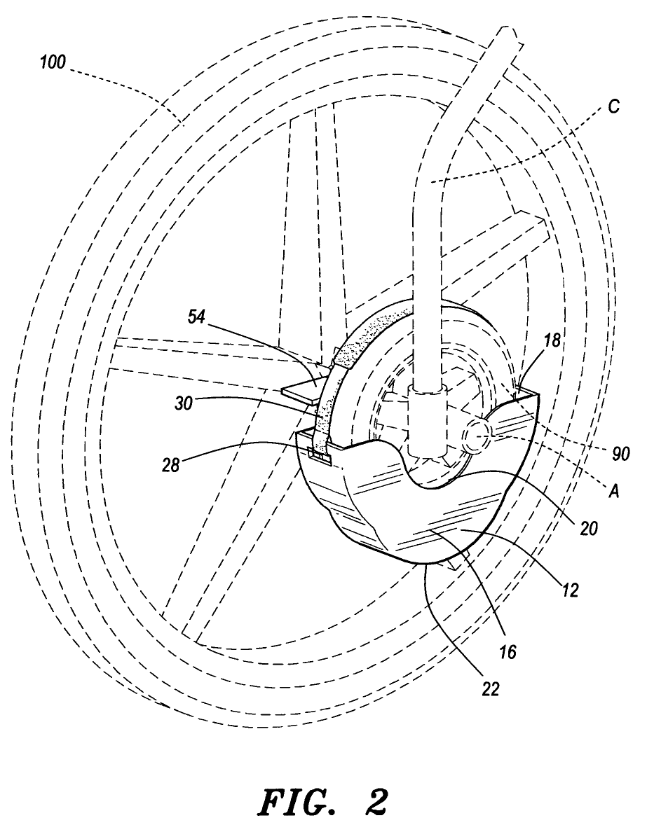

A preferred embodiment of the adaptor 10 is illustrated in FIGS. 1 to 3.

The adapter 10 is configured to attach an auxiliary wheel 100 to a wheel 90 of a conveyance device C, and a wheel cradle 12 that receives a conveyance wheel 90 attached to an axle A of the conveyance device C.

The wheel cradle 12 has first 14 and second 16 parallel disposed walls forming a wheel receiving channel 18. A central portion of the second wall 14 contains an axle receiving recess 20 allowing a wheel 90 of a conveyance device C to be received in the wheel receiving channel 18 without interfering with the axle assembly A of the conveyance device C.

A wheel support floor 22 is disposed between lower edges of the first 14 and second 16 parallel disposed walls for supporting the lower portion of a conveyance wheel 90. The wheel receiving channel 18 is configured in such a manner as to allow difference sized conveyance wheels 90 to be received therein.

An axle receiving bore 24 is disposed on and projects from an exterior portion of the first wall 14, wherein the axle receiving bore 24 is configured to receive an axle assembly of an auxiliary wheel 100. A plurality of gussets 26 are disposed on an exterior surface of the first wall 14 extend in a radial direction from an outward supporting surface of the axle receiving bore 24. The plurality of gussets 26 reinforce the axle receiving bore 24 when an axle of an auxiliary wheel 100 is inserted therein.

A strap attachment portion 28 is located on an upper front and an upper rear area of wheel cradle 12, proximate to the opening of the wheel receiving channel 18. One end of an attachment strap 30 is connected to a first attachment portion 28 of the wheel cradle to enable the attachment strap 30 to wrap around a top exposed portion of a wheel 90 of a conveyance device C received in the wheel receiving channel 18. A second end of the attachment strap 30 is connected to a second attachment portion 28 to releasably secure a wheel 90 of the conveyance device C within the wheel receiving channel 18. The strap may comprise of mating hook and loop fasteners for easily releasable secure fastening.

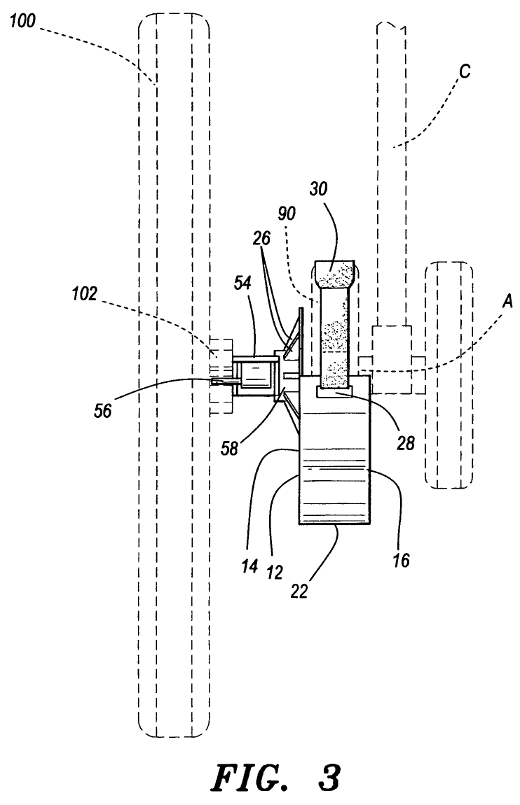

The adapter 10 may also include a removable locking mechanism 50 that allows the locking of an auxiliary wheel 100 with respect to the conveyance device C. A axle receiving collar 52 is configured to receive an axle assembly of an auxiliary wheel 100 and further includes a locking lever 54 rotatably disposed on a peripheral surface of the axle receiving collar 52. A locking rod 56 extends in an outward direction parallel to the axial direction of the axle receiving collar 52, wherein the locking rod 56 is configured to releasably engage a locking sprocket 102 (shown in FIG. 3) of an auxiliary wheel 100. A gusset mating crown 58 attached to the inward end of the collar 52 projects in an inward direction parallel to the axial direction of the axle receiving collar 52. The crown 58 contains a plurality of longitudinal slots 60 formed in a peripheral edge thereof, wherein the longitudinal slots 60 are configured to receive the plurality of gussets 26 on the wheel cradle 12 when the locking mechanism 50 is aligned in an axial direction with the axle receiving bore 24 of the wheel cradle 12 when the crown 58 extends over a portion of the axle receiving bore 24. (See FIG. 3.)

The wheel cradle 12 has an outside top lip on the first wall 14 extending above the axial receiving bore 24 allowing for attachment of auxiliary components such as wheel covers or fenders. The wheel receiving channel 18 is wide and long enough to accommodate a wide range of typical personal conveyance wheels, and may include internal longitudinal ridges to further restrict lateral movement, sway or friction between the wheel cradle 12 and the attached conveyance wheel 90. The outside, bottom side of the wheel cradle 12 is of a shape that allows it to rest firmly on the ground, when the conveyance wheel 90 is placed within the wheel receiving channel 18 with no attached auxiliary wheel.

A wheel cradle lateral stabilizer may be attached through the first wall 14 of the wheel cradle 12 to provide a lateral force to the conveyance wheel 90 received in the wheel receiving channel 18. The cradle lateral stabilizer may comprise a screw operable to be tightened against a lateral portion of a conveyance wheel received in the wheel receiving channel 18 to provide for a lateral stabilizing force between the wheel cradle and the attached conveyance wheel 90.

The overall size and proportion of the wheel cradle 12 may be adapted to receive various diameters and widths of conveyance wheels. A typical embodiment of a cradle would be one that accommodates stroller, hand truck and dolly wheels of ten to twenty centimeters (about four to eight inches) diameter, and one to five centimeters (about one-half to two inches) width.

The axle receiving bore 24 may provide an axle locking attachment mechanism, as is commonly found in various manifestations on personal conveyances with removable wheels.

A further preferred characteristic is that the center of an auxiliary wheel's diameter, when attached to the wheel cradle 12, is higher from the ground than the center of the conveyance wheel 90. Additionally, the diameter of an attached auxiliary wheel 100 is greater than the greater of either the conveyance wheel 90 diameter or the height of the wheel cradle 12, when perpendicular to the ground.

Operation of this invention is intended to be executed by an individual capable of elevating and maneuvering the personal conveyance, without need of additional assistance, tools, or parts beyond the wheel cradle and auxiliary wheel. First, the conveyance wheel 90 is placed snugly and centered within the wheel receiving channel 18 of the cradle 12. Second, the wheel cradle 12 is fastened to the conveyance wheel 90 using the adjustable attachment strap 30. Optionally, a cradle lateral stabilizer may be adjusted to firmly pressing laterally against the conveyance wheel 90. Finally, an auxiliary wheel 100 or alternative device is attached and locked to the wheel cradle 12 at the axle receiving bore 24.

A lightweight plastic embodiment of this invention may accommodate the load commonly associated with a small, lightweight child's stroller, whereas a sturdier metal embodiment of this invention would better accommodate a utility wagon transporting heavy rocks or concrete. The embodiments of the cradle strap and the axle receiving bore are intended likewise to match the target conveyance wheel type, size and load target weight range. For example, the fastener strap would be lightweight fabric for small, lightweight child's strollers, but would be more sturdy canvas, rubber or metal to accommodate larger wheels and heavier loads and associated multi-directional physical stress.

Distinct, alternative embodiments are intended for design and use adjustments. For example, the shape of the wheel cradle may be more or less curved for various reasons and purposes. The outside bottom of the wheel cradle may be flat and horizontal to the ground, for instance, thereby facilitating attachment of the target conveyance wheel while the wheel cradle assembly rests on the ground. For another example, distinct or collective elements of the wheel cradle assembly may embody curvature or texture specifically designed for easy grip, certain target conveyance wheel types or sizes, or targeted aesthetic value and intention. As well, the wheel cradle may be composed of various materials, of various densities, with various physical natures and surfacing, according to best use and aesthetic value.

The wheel cradle can be embodied in innumerable shapes, sizes, colors and materials, so long as its intended function is preserved. The shapes, sizes, colors and materials could add additional value to its core function, for example achieving buoyancy in water, reflectivity at night, aerodynamics at high speed, protection of the conveyance and load from water and mud spray, and adding decorative value for entertainment, advertisement, sport or child's play. The wheel cradle can include multiple auxiliary wheel or device attachment points, or accommodate the fastening to multiple conveyance wheels. The wheel cradle can itself accommodate additional attachment points for other items, for example a high visibility flag, a stabilizer bar to be attached across two cradles thus achieving directional parallelism, or additional spring or shock mechanisms to provide additional shock absorption. A fastener assembly attached to the wheel cradle can itself be embodied in innumerable ways, from flexible, single straps to rigid, enclosed collars.

It is to be understood that the present invention is not limited to the embodiments described above, but encompasses any and all embodiments within the scope of the following claims.

1. An adapter to attach an auxiliary conveyance device to a primary conveyance device, said adapter comprising:
A) a wheel cradle including:
1) first and second parallel disposed walls forming a wheel receiving channel configured to receive a wheel of a conveyance device;
2) a wheel support floor disposed between lower edges of said first and second parallel disposed walls;
3) an axle receiving bore disposed on and projecting from an exterior portion of said first wall, said axle receiving bore configured to receive an axle assembly of an auxiliary wheel; and
4) at least one strap attachment portion on said wheel cradle; and
B) an attachment strap connected to said at least one strap attachment portion of said wheel cradle, said attachment strap configured to releasably secure a wheel of a conveyance device within said wheel receiving channel.

2. The adapter to attach an auxiliary conveyance device to a primary conveyance device of claim 1, further comprising:
a plurality of gussets disposed on an exterior surface of said first wall radially extending from an outward supporting surface of said axle receiving bore.

3. The adapter to attach an auxiliary conveyance device to a primary conveyance device of claim 2, further comprising a removable locking mechanism including:
an axle receiving collar, said axle receiving collar configured to receive an axle assembly of an auxiliary wheel therethrough;
a locking lever rotatably disposed on a peripheral surface of said axle receiving collar including a locking rod extending in an outward direction parallel to the axial direction of said axle receiving collar, said locking rod configured to releasably engage a locking sprocket of an auxiliary wheel; and
a gusset mating crown projecting in an inward direction parallel to said axial direction of said axle receiving collar, said crown containing a plurality of longitudinal slots formed in a peripheral edge, said longitudinal slots configured to receive said plurality of gussets when said locking mechanism is aligned in an axial direction with said axle receiving bore of said wheel cradle and said crown extends over a portion of said axle receiving bore.

4. The adapter to attach an auxiliary conveyance device to a primary conveyance device of claim 1, wherein said attachment strap includes at least a portion of hook and loop fasteners.

5. The adapter to attach an auxiliary conveyance device to a primary conveyance device of claim 1, wherein said wheel cradle further comprises:
an axle receiving recess in a central portion said second wall, said axle receiving recess configured to receive an axle portion of a conveyance device wheel.

6. A method of attaching an auxiliary conveyance device to a wheeled conveyance device by means of an adapter, said adapter including a wheel cradle having first and second parallel disposed walls forming a wheel receiving channel, a wheel support floor disposed between lower edges of said first and second parallel disposed walls, an axle receiving bore disposed on and projecting from an exterior portion of said first wall, said axle receiving bore configured to receive an axle assembly of an auxiliary wheel, at least one strap attachment portion on said wheel cradle, said adaptor further including an attachment strap connected to said at least one strap attachment portion of said wheel cradle, said method comprising the steps of:
placing a conveyance device wheel in said wheel receiving channel of said wheel cradle;
securing said attachment strap around said conveyance wheel to two attachment points on said wheel cradle; and
attaching an axle-of an auxiliary wheel into said axle receiving bore of said wheel cradle.

7. The method of attaching an auxiliary conveyance device to a wheeled conveyance device by means of an adapter of claim 6, further comprising the steps of:
attaching a removable locking mechanism to said axle of said auxiliary wheel;
attaching said axle of said auxiliary wheel and with said attached removable locking mechanism into said axle receiving bore of said wheel cradle.

8. A removable locking mechanism for removable attachment to an adapter for attaching an auxiliary conveyance device to a primary conveyance device, said removable locking device comprising:
an axle receiving collar, said axle receiving collar configured to receive an axle assembly of an auxiliary wheel therethrough;
a locking lever rotatably disposed on a peripheral surface of said axle receiving collar including a locking rod extending in an outward direction parallel to the axial direction of said axle receiving collar, said locking rod configured to releasably engage a locking sprocket of an auxiliary wheel; and
a gusset mating crown projecting in an inward direction parallel to said axial direction of said axle receiving collar, said crown containing a plurality of longitudinal slots formed in a peripheral edge, said longitudinal slots configured to receive a plurality of gussets when said locking mechanism is aligned in an axial direction with an axle receiving bore of a wheel cradle and said crown extends over a portion of said axle receiving bore.
